(19) United States
(12) Patent Application Publication
(10) Pub. No.: US 2019/0291547 A1
(43) Pub. Date: Sep. 26, 2019

(54) SUN-PROTECTION ROLLER BLIND, SLIDING ROOF SYSTEM WITH SUCH A SUN-PROTECTION ROLLER BLIND AND METHOD FOR PRODUCING A SUN-PROTECTION ROLLER BLIND

(71) Applicant: Roof Systems Germany GmbH, Dietzenbach (DE)

(72) Inventors: Christian IHLO, Darmstadt (DE); Thomas BECHER, Rodgau (DE); Joachim RÖDER, Mühlheim (DE); Christian BIEWER, Münster (DE); Franz ADELMANN, Offenbach (DE)

(21) Appl. No.: 16/463,260

(22) PCT Filed: Nov. 8, 2017
(86) PCT No.: PCT/EP2017/078658

§ 371 Date: May 22, 2019

(30) Foreign Application Priority Data
Nov. 24, 2016 (DE) 10 2016 122 700.5

(51) Int. Cl. B60J 7/00; B60J 1/20

(52) U.S. Cl. CPC B60J 7/0015; B60J 1/2041; B60J 1/2052

(57) ABSTRACT

A sun-protection roller blind for a motor vehicle, with a flat roller blind body and two guide bands which extend along two edges of the roller blind body, in which the guide bands are made of plastic and the roller blind body is welded to the guide bands. A sliding roof system with two guide rails in which the guide bands of such a sun-protection roller blind are received. A method for producing such a sun-protection roller blind, in which the roller blind body is thermally welded to the guide bands by means of ultrasound or by means of a stamp.

The invention relates to a sun-protection roller blind for a motor vehicle, with a flat roller blind body and two guide bands which extend along two edges of the roller blind body. The invention also relates to a sliding roof system with such a sun-protection roller blind and a method for producing the sun-protection roller blind.

In a sliding roof system for a motor vehicle, the sun-protection roller blind is usually arranged underneath a roof opening. It can be moved between a pushed back position, in which the roller blind is located outside the roof opening, and a more or less extended (or pushed forward) position, in which the roof opening is more or less covered. Solar radiation can hereby be prevented from penetrating directly into the vehicle interior.

In addition to the primary function of shading, the sun-protection roller blind can also have the function of shielding from the headwind if, when the cover of the sliding roof system is open, it is in the extended position.

In many cases, the sun-protection roller blind when pushed back is rolled up onto a reel in space-saving manner. In order to make this possible, the guide bands and the roller blind body are flexible. The guide bands can consist of spring steel, and the roller blind body can consist of a film material, a woven fabric or similar material.

If the guide bands consist of spring steel, the roller blind body is usually glued to these. Gluing is in many respects not ideal. Firstly, a curing time is required which increases the process time. Secondly, there is the risk with a glued joint of creep, thus a slow displacement of the roller blind body relative to the guide bands.

It is also known from the state of the art to sew the roller blind body to the guide bands. However, the disadvantage of this is that a perforated guide band is required.

The object of the invention consists of creating a sun-protection roller blind which can be produced with a small outlay and is characterized by good operating properties.

To achieve this object, it is provided according to the invention that the guide bands consist of plastic and the roller blind body is welded to the guide bands. The invention is based on the knowledge that by means of a weld seam the desired connection between the guide bands and the roller blind body can be produced with a small outlay, in a short time and with high fatigue strength. In contrast to the state of the art, where it was necessary to provide additional joining means (adhesive, thread, rivet etc.) for fastening the roller blind body to the guide bands, such additional joining means are no longer required in the case of the invention. In addition, a guide band made of plastic requires less outlay in the area of the assigned guide rail for optimum sliding and low noise generation. In the state of the art it was in some cases necessary to line guide rails made of aluminium with their own plastic rail inside in order to keep friction and the noise level low. In the case of the present invention, in contrast, guide rails made of metal, for example aluminium, without an internal lining can now be used, which also results in a significant cost reduction.

A polyester material is preferably used as material for the guide bands. This is characterized by a good weldability accompanied by low material costs.

In particular, polyethylene terephthalate (PET), polybutylene terephthalate (PBT) or polycarbonate (PC) is used for the guide bands. These materials guarantee the desired flexibility over a long lifetime.

The weld seam preferably extends over less than 50% of the width of the guide bands, which is an advantage with respect to the amount of energy that has to be expended for the welding.

According to a preferred embodiment, it is provided that the weld seam extends over 20 to 35% of the width of the guide bands. The advantage of such a narrow weld seam is (in addition to the comparatively small amount of energy required for the welding) that a very large area of the guide bands remains free, which leads to a low level of friction between the sun-protection roller blind and the guide rails in which the guide bands are received.

The guide bands preferably have a thickness in the range of from 250 μm to 500 μm. It has transpired that these values represent a good compromise between strength on the one hand and small dimensions in the rolled-up state on the other hand.

Polyester is in particular suitable as material for the roller blind body. This material is characterized by a high mechanical strength, a good durability and a good weldability.

To achieve the above-named object there is also provided according to the invention a sliding roof system with two guide rails in which the guide bands of a sun-protection roller blind of the type explained above are received. In addition to the advantages explained above in relation to the sun-protection roller blind, the advantage results that the guide bands consisting of plastic slide in the guide rails with a low level of friction and very low noise.

The guide rails are made in particular of metal, particularly advantageously of aluminium, and do not have a lining or the like in the area of contact with the guide bands, with the result that the sun-protection roller blind lies directly against the guide rail.

The guide rails preferably have a C-shaped cross section. With this shape a low construction height can be achieved, while at the same time the guide bands are reliably guided in the guide rails.

According to an embodiment of the invention, it is provided that the roller blind body does not come into contact with the inside of the guide rails. This embodiment is characterized by a particularly low level of friction when the sun-protection roller blind is moved as only the guide bands consisting of plastic slide in the guide rails.

According to an alternative embodiment, it is provided that the edges of the roller blind body lie against the inside of the guide rails. With this design the angle between the roller blind body and the guide bands can be minimized, which is effective in terms of peeling the roller blind body off the guide bands. A high resilience of the weld joint is thus achieved.

The insides of the short sides of the guide rails are preferably offset with respect to each other, with the result that the installation space in the z direction of the vehicle is minimized.

To achieve the above-named object there is finally provided a method for producing a sun-protection roller blind of the above-named type, in which the roller blind body is thermally welded to the guide bands by means of ultrasound or by means of a stamp. This method is characterized by a high process stability.

The welding temperature preferably lies in the range of from 250° C. to 300° C. In this temperature range, on the one hand there results a very resilient weld seam between the roller blind body and the guide bands, while on the other hand there is no risk of damage to the roller blind body during the welding.

The invention is described below with reference to various embodiments which are represented in the attached drawings. In the drawings,

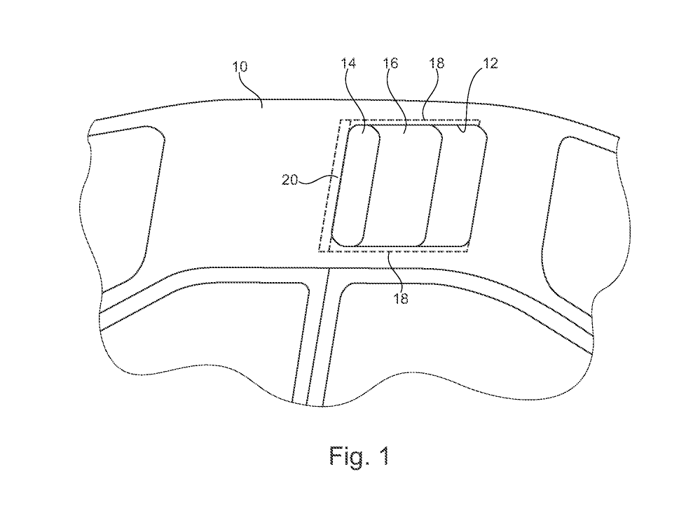

FIG. 1 schematically shows a motor vehicle with a sliding roof system according to the invention arranged in the roof, which is equipped with a sun-protection roller blind according to the invention;

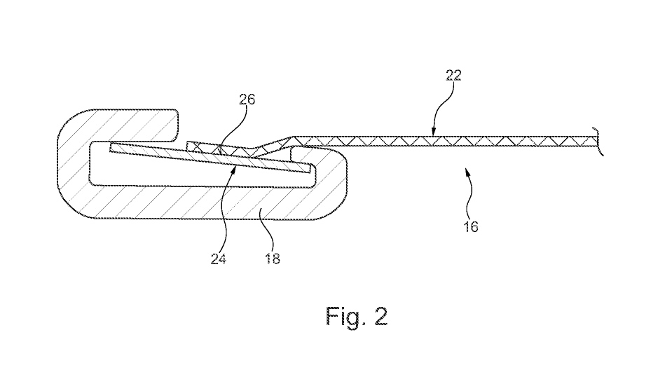

FIG. 2 shows a schematic section cross of a sun-protection roller blind according to a first embodiment;

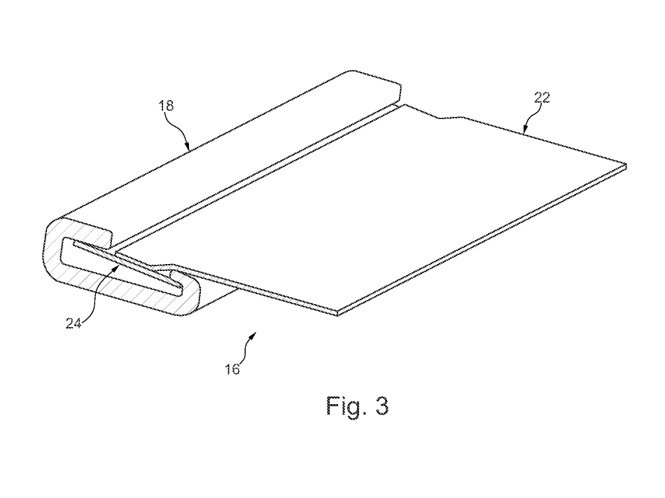

FIG. 3 shows a schematic perspective view of the sun-protection roller blind of FIG. 2;

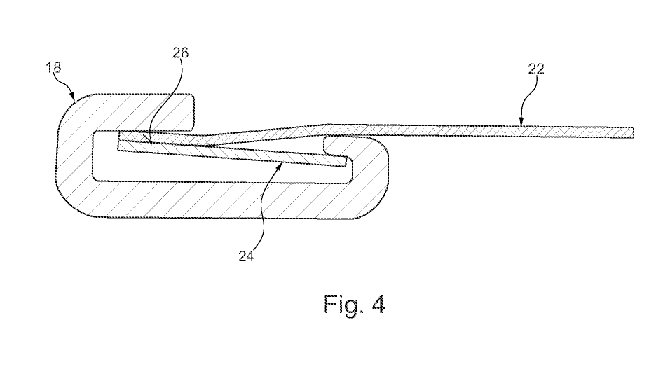

FIG. 4 shows schematic view corresponding to that of FIG. 2 of a sun-protection roller blind according to a second embodiment;

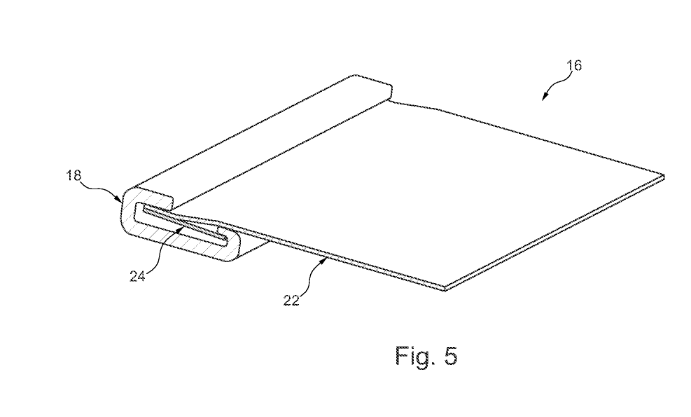

FIG. 5 shows a schematic perspective view of the sun-protection roller blind of FIG. 4; and

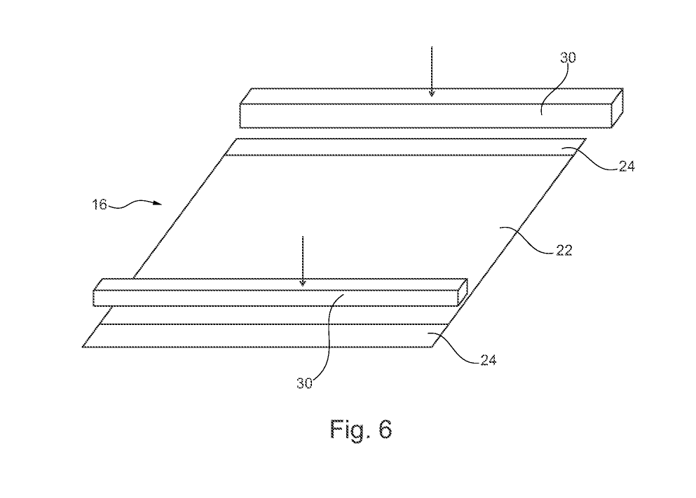

FIG. 6 shows a schematic view of various steps in the production of a sun-protection roller blind according to the invention.

FIG. 1 schematically shows a vehicle roof 10 with a roof opening 12 in which a cover of a sliding roof system is movably arranged. Underneath the cover 14 there is arranged a sun-protection roller blind 16 which can be moved forwards and backwards in two guide rails 18, indicated schematically, which extend along the longitudinal direction of the vehicle.

The components of the sliding roof system by means of which the cover 14 can be moved are known per se and are therefore not shown here.

The sun-protection roller blind 16 largely covers the roof opening 12 when it is completely extended. In order to uncover the roof opening 12, the roller blind can be pushed backwards, wherein it then rolls up onto a reel 20, indicated schematically here.

The sun-protection roller blind 16 consists of a roller blind body 22 which has a rectangular shape, as well as two guide bands 24 which extend along two side edges of the roller blind body 22 that are parallel to each other. The two guide bands 24 are received in the guide rails 18 such that the sun-protection roller blind 16 can be moved in them.

The roller blind body 22 consists of a flexible material that can be rolled up onto the reel 20. It can be a woven fabric, a film, a knitted fabric or another material with which the desired shielding of the vehicle interior from solar radiation and also headwind can be achieved. Polyester can particularly preferably be used.

The two guide bands 24 are flat, narrow strips made of plastic. The width is in the range of from 6 mm to 10 mm, and the height is in the range of from 250 μm to 500 μm.

A polyester, in particular polyethylene terephthalate (PET), polybutylene terephthalate (PBT) or polycarbonate (PC), is used as material for the guide bands 24.

In the embodiment shown in FIGS. 2 and 3 the roller blind body 22 is joined to the guide bands 24 approximately in the centre on one side. The roller blind body 22 is welded to the guide bands 24 (see the weld seam 26).

The width of the weld seam here is in the range of from 25 to 30 percent of the width of the corresponding guide band 24.

In cross section the guide rails 18 have the shape of a very shallow C, wherein the roller blind body 22 leaves the internal cross section of the guide rails 18 in the area between the two short sides. Because the roller blind body 22 is joined to the guide bands 24 approximately in the centre here, the guide bands 24 are supported on the inside of the cross section of the guide rails 18 without the roller blind body 22 coming into contact with the inner surfaces of the guide rail 18.

It can be seen in FIG. 2 that the short side of the C-shaped cross section arranged towards the centre of the vehicle (thus the side lying on the right-hand side) is arranged at a lower level than the side lying on the outside of the vehicle. The guide band 24 is therefore inclined slightly in the guide rail 18, with the result that the weld seam is slightly “raised”. The roller blind body 22 therefore runs more easily over the inner side of the guide rail 18.

A second embodiment is shown in FIGS. 4 and 5. The same reference numbers are used for the components known from the preceding embodiment, and reference is made in this respect to the above explanations.

The difference between the first and the second embodiments is that in the second embodiment, the roller blind body 22 is welded to the side of the guide bands 24 facing away from the centre of the vehicle. The roller blind body 22 thus contacts the inside of the outward leg of guide rail 18. In the same way as in the first embodiment, here too the two inner surfaces of the short sides are at different levels with the result that the guide band 24 is inclined such that the friction between the roller blind body 22 and the side of the guide rail 18 lying inside is reduced.

FIG. 6 shows schematically the method for producing of the sun-protection roller blind 16. The guide bands 24 are arranged along two side edges of the roller blind body 22 and then welded to the side edges by means of a welding device 30.

The welding device 30 can either be an ultrasonic welding device or it can contain a hot-stamping stamp which introduces the heat required for the welding as contact heat.

A temperature range of from 250 to 300° C. has proved particularly suitable as suitable welding temperature.

The weld joint with the weld seam 26 between the roller blind body 22 and the guide bands 24 has proved very mechanically durable. At the same time, it does not hinder the rolling up of the sun-protection roller blind 16 onto a reel. A very compact reel also results at the side edges due to the comparatively small thickness of the guide bands 24.

In all of the embodiments the guide rails 18 are made of metal, in particular aluminium. The sun-protection roller blind 16 is in direct contact with the guide rails 18; this means that the guide rails 18 do not have a lining or an interposed sliding element inside at least in the area of contact with the sun-protection roller blind 16. In order to keep the costs low, no linings or interposed accompanying elements such as plastic rails whatsoever are provided inside in the guide rails 18. The installation space can thus also be reduced.

1. A sun-protection roller blind for a motor vehicle, with a flat roller blind body and two guide bands which extend along two edges of the roller blind body, wherein the guide bands consist of plastic and the roller blind body is welded to the guide bands, wherein the weld seam extends over less than 50% of the width of the guide bands.

2. The sun-protection roller blind according to claim 1, wherein the guide bands consist of a polyester material.

3. The sun-protection roller blind according to claim 1, wherein the guide bands consist of polyethylene terephthalate (PET), polybutylene terephthalate (PBT) or polycarbonate (PC).

4. The sun-protection roller blind according to claim 1, wherein the weld seam extends over 20 to 35% of the width of the guide bands.

5. The sun-protection roller blind according to claim 1, wherein the guide bands have a thickness in the range of from 250 μm to 500 μm.

6. The sun-protection roller blind according to claim 1, wherein the roller blind body consists of polyester.

7. A sliding roof system with two guide rails in which the guide bands of a sun-protection roller blind according to claim 1 are received.

8. The sliding roof system according to claim 7, wherein the guide rails have a C-shaped cross section.

9. The sliding roof system according to claim 8, wherein the roller blind body does not come into contact with an inside of the guide rails.

10. The sliding roof system according to claim 8, wherein the edges of the roller blind body lie against the inside of the guide rails.

11. The sliding roof system according to, claim 7, wherein insides of short sides of the guide rails are offset with respect to each other.

12. The sliding roof system according to claim 7, wherein the guide rails are made of metal and the sun-protection roller blind lies directly against the guide rails.

13. A method for producing a sun-protection roller blind according to claim 1, wherein the roller blind body is welded to the guide bands by means of ultrasound or by means of a stamp.

14. The method according to claim 13, wherein the welding temperature lies in the range of from 250° C. to 300° C.

15. The sliding roof system according to claim 12, wherein the guide rails are made of aluminium.
